(19) United States
(12) Patent Application Publication
(10) Pub. No.: US 2004/0208966 A1
(43) Pub. Date: Oct. 21, 2004

(54) Minimal pulp beverage and methods for producing the same

(75) Inventors: S. Harapanahalli Muralidhara, Plymouth, MN (US); Howard Nivens, Winter Haven, FL (US); Jose Passarelli, Bebeduro (BR)

Correspondence Address: Cargill, Inc., Intellectual Property Department, Legal Department, 15407 McGinty Road West, Wayzata, MN, 55391-2399, US

(73) Assignee: Cargill Inc., Wayzata, MN

(21) Appl. No.: 10/414,427

(22) Filed: Apr. 15, 2003

(51) Int. Cl. C12H 1/04

(52) U.S. Cl. 426/422

(57) ABSTRACT

A low pulp beverage is made by passing a feed juice through a filter aid to form a retentate and a filtrate. The filtrate has from between 0.01% to about 2% solids by volume. Substantial portions of the solids are particles sized from between 30 to about 200 microns, and the low pulp beverage has a cloud stable for at least 15 days.

### FIELD OF THE INVENTION

The invention relates to fruit beverages and methods of producing fruit beverages with decreased levels of pulp presenting stable clouds.

### BACKGROUND OF THE INVENTION

Recently, the health benefits such as the disease retarding and treating benefits of fruit juices have come to be more fully recognized as advantageous and beneficial. Accordingly, there is a general belief that increasing the intake of fruits and fruit juices is a beneficial and important objective. Among fruits, citrus fruits have long been recognized as valuable sources of important nutrients. Many factors influence the quality of citrus products, including juices. To consumers, the look, taste, flavor, acidity, bitterness or tartness, color, and texture are important considerations for acceptance of these products.

Segments of the population, however, are less than enthusiastic about certain characteristics of citrus products, such as bitterness, acidity, pulp, and a thick consistency. Citrus fruits presenting these types of concerns include orange, tangerine, grapefruit, lime, and lemon fruits.

Regarding the look of the juice, consumers expect certain fruit beverages to be cloudy rather than clear. Citrus juices, when freshly expressed, have a characteristic opacity of cloudiness. It is obviously desirable to maintain this opacity in processing citrus juices, and to emulate it in formulated citrus beverages. In natural juices, a “cloud” is provided by minute suspended or colloidal particles of citrus tissue and cell contents.

In previous methods, pulp was removed from fruit juice by first screening to remove coarse pulp. The screened juice was then subjected to conventional centrifugation to remove much of the insoluble solid material. Other previous methods for depulping orange juice included, screening with a vibrating mesh then screening with a finishing press.

The known methods of providing a nutritious fruit juice having low pulp levels, a stable cloud, desirable flavor, fragrance, and mouthfeel are not adequate because the cloud is not stable for long periods of time at room temperature and the methods are expensive and time-consuming.

It is an object of the present invention to provide a fruit beverage with low pulp levels that reduces or wholly overcomes some or all of the difficulties inherent in prior known processes. Particular objects and advantages of the invention will be apparent to those skilled in the art, that is, those who are knowledgeable or experienced in this field of technology, in view of the following disclosure of the invention and detailed description of certain preferred embodiments.

### SUMMARY

In accordance with a first aspect, a process of producing a low pulp beverage comprises providing a feed juice, providing a filter apparatus, and providing a filter aid. The feed juice is passed through the filter aid and the filter to form a retentate and a filtrate. The filtrate produced has from between 0.01% to about 2% solids by volume.

In accordance with a second aspect, a low pulp beverage comprises from between about 0.01% to about 2% solids by volume, wherein a substantial portion of the solids are particles sized from between 30 to about 200 microns. The juice also has a cloud stable for at least 15 days.

In accordance with a third aspect, a low pulp beverage is produced by the process comprising, providing a feed juice, providing a filter apparatus, and providing a filter aid. The feed juice is then passed through the filter aid and the filter to form a retentate and a filtrate, wherein the filtrate has from between 0.01% to about 2% solids by volume.

In accordance with a fourth aspect, a low pulp beverage is produced by the process comprising, providing a feed juice comprising from between 5° to about 300 Brix, passing the feed juice through a heat exchanger, and providing a filter apparatus. The filter apparatus comprises a filter comprising from about 20 to about 60 microns. A filter aid is provided comprising from between about 0.01 to about 5% by weight of the feed juice. Vacuum pressure is provided on the filter apparatus at from between about 5 mm Hg to about 20 mm Hg. The filter apparatus is rotated at from between 0.01 rpm to about 30 rpm. The juice is filtered through the filter aid and the filter at a rate of from between 1 gpm/square meter to about 20 gpm/square meter to produce a filtrate and a retentate, wherein the filtrate has from between about 0.01% to about 2% solids by volume and a cloud stable for at least 15 days.

Substantial advantage is achieved by providing a filter aid and a filter to selectively size select particulate matter of from between 30 to about 200 microns. In particular, substantial advantage is achieved by providing a heat exchanger to maintain the temperature of the feed juice and filtrate at or below ambient temperatures. This is highly advantageous since flavor, fragrance, and mouthfeel of the feed juice and retentate is lost when the feed juice is maintained at temperatures higher than ambient temperatures.

These and additional features and advantages of the invention disclosed here will be further understood from the following detailed disclosure of certain preferred embodiments.

### BRIEF DESCRIPTION OF THE DRAWINGS

Various embodiments of the invention are described below with reference to the accompanying drawings in which:

FIG. 1 is a simplified drawing of an apparatus that produces a low pulp beverage;

FIG. 2 is a simplified drawing of an apparatus that produces a low pulp beverage;

FIG. 3 is a simplified process flow diagram of an apparatus that produces a low pulp beverage;

FIG. 4 is a simplified process flow diagram of an apparatus that produces a low pulp beverage;

FIG. 5 is a simplified process flow diagram of an apparatus that produces a low pulp beverage;

FIG. 6 is a simplified process flow diagram of an apparatus that produces a low pulp beverage, including a rotating vacuum filter apparatus;

FIG. 7 is a simplified process flow diagram of an apparatus that produces a low pulp beverage, including a further processing by filter evaporation;

FIG. 8 is a graph of the particle size distribution of the feed juice and the feed juice filtered with a Whatman #4 filter paper;

FIG. 9 is a graph of the particle size distribution of a feed juice filtered with Celite Sample A;

FIG. 10 is a graph of the particle size distribution of a feed juice filtered with Perlite low grade;

FIG. 11 is a graph of the particle size distribution of a feed juice filtered with Perlite medium grade; and

FIG. 12 is a graph of the particle size distribution of a feed juice filtered with Perlite high grade and Perlite high grade with a shallow bed.

The figures referred to above are not drawn necessarily to scale and should be understood to present a representation of the invention, illustrative of the principles involved. Some features of the method of concentrating juice and the juice concentrate produced by practicing the method depicted in the drawings have been enlarged or distorted relative to others to facilitate explanation and understanding.

### DETAILED DESCRIPTION OF CERTAIN PREFERRED EMBODIMENTS

The examples given here are only illustrative, and it should be understood that these process are appropriate for any type of fruit juice. A person skilled in the art, having the benefit of this disclosure would know how to adapt the examples given for their particular purpose.

A low pulp beverage is produced, which avoids excessive loss of turbidity. The opalescence of the juice, as well as the viscosity, acidity, and sugar content also are maintained in the process. In addition, a beverage may be produced that has a low pulp level with no impairment of flavor and fragrance properties. This low pulp juice may be prepared, according to one aspect of the invention, by providing a feed juice, a filter apparatus comprising a filter, and a filter aid. The feed juice may be passed through the filter aid and the filter to form a retentate and a filtrate, wherein the filtrate may have from between 0.01% to about 2% solids by volume. The filtrate may also have less than 1% solids by volume or even less than 0.5% solids by volume.

As used here, a feed juice may be, for example, a processed juice, an unprocessed juice, or any other type of juice a person with skill in the art having the benefit of this disclosure would find appropriate for a particular purpose. An unprocessed juice includes juices that have not been further processed after extraction. Unprocessed juices may include substantially all of the suspended solids of the extracted juice. An unprocessed juice may be, for example, freshly extracted, extracted then frozen and thawed, a mixture of freshly extracted juices, or a juice otherwise similarly treated by a method known in the art. Processed juices include juices that have been processed, for example, by being centrifuged, sheared, heat treated, membrane filtered, concentrated, evaporated, pressure treated, pulverized, reconstituted, core washed, enzyme treated, and/or other methods known to those of skill in the art having the benefit of this disclosure.

A water extracted juice (also known as core washed juice) includes juices that have processed, for example, by washing the core material that exits the strainer tube of an extractor with water to recover orange soluble solids. After the extraction, the recovered orange soluble solids may be, for example, filtered, centrifuged, treated with pectolytic enzymes, pasteurized, and/or debittered. The core washed juice may then be optionally concentrated to from about 12° Brix to about 65° Brix. The feed juice comprised of water extracted juice or core washed juice may be used, for example, in a concentrated form, in a not-from-concentrate form, in a reconstituted form, or in any other form a person with skill in the art having the benefit of this disclosure would determine appropriate for their particular purpose.

According to one aspect, the feed juice may comprise from between 5° Brix to about 65° Brix. A Brix level, however, of from between 9° Brix to about 15° Brix is preferred in some aspects because it is the usual Brix level of freshly squeezed juice. In other aspects, a more concentrated juice of from between 22° Brix to about 65° Brix is used because it is less expensive to ship a concentrated juice. The concentrated juice may optionally be reconstituted. The optimal level of Brix will depend, in part, on the type of fruit from which the juice is extracted. One with skill in the art, having the benefit of this disclosure would be able to determine the proper level of Brix to suit their particular purpose.

The feed juice may contain from between 5% to about 15% solids by volume. Solids, as used here, include, for example, pulp solids, fruit solids, suspended solids, and other materials and particulate matter understood by one with skill in the art to be solids. The solids may be, for example, components of a freshly squeezed juice, particulate matter that falls out of the solution of a juice, or the solids may be added to the feed juice. The solids may be, for example, from between about 0.001 to about 1000 microns and above.

The feed juice, according to certain aspects, may be derived from citrus fruit, including, but not limited to, oranges, grapefruit, limes, tangerines, lemons, and tangelos. Alternately, one may derive the feed juice from apricot, cranberry, blueberry, grape, peach, pear, papaya, banana, pineapple, apple, kiwi, raspberry, strawberry, aloe, guava, mango, or a mixture.

Feed juice extracted from oranges may be made, for example from four varieties of oranges, Pineapple, Hamlin, Parson Brown, and Valencia oranges. Tangerines, mandarin oranges, blood oranges, and naval oranges can also be used. The juices from these oranges can be used alone or blended to produce optimum flavor characteristics.

Juice extraction can be carried out by any method known of obtaining juice from fruits, such as by automatic juicing machines, by hand, or by an FMC extractor. In some aspects, such as when using a citrus fruit, a method that minimizes extraction of peel oil is preferred. An optional step is to centrifuge the juice once separated from the rag and seeds to remove the oil from the juice because peel oil contributes a bitter note to orange juice.

The filter apparatus provided, according to some aspects of the invention, may comprise at least one reservoir. In other aspects, the filter apparatus may comprise a filter. Filters for example, may be made of cloth, sintered glass, paper, plastic, polymer, or any material a person having skill in the art would find appropriate for their particular purpose. The filter may comprise pores of from between 30 to about 50 microns. Such filters are commercially available, for example, from Whatman. The filter may be from 1 to about 80 square meters. In some aspects the filter is from between 40 to about 60 square meters. The filter may be of any size and one with skill in the art having the benefit of this disclosure will be able to determine the proper size for a filter for their particular purpose.

In some aspects, the filter apparatus may be, for example, a vacuum filter apparatus, a rotating drum filter apparatus, a rotating vacuum drum filter apparatus, or other filter apparatus a person with skill in the art having the benefit of this disclosure would find appropriate for their particular purpose. In a filter apparatus using vacuum pressure, such as a vacuum filter apparatus or a rotating vacuum filter apparatus, vacuum pressure provided to the filter apparatus may be, for example, from between 5 mm Hg to about 30 mm Hg. In some aspects the vacuum pressure may be from 10 to about 20 inches Hg. Such vacuum filter apparatuses may be found commercially, for example, from Eimco, Komline Sanderson, or Mansa. Filter apparatuses using rotation, such as a rotating drum filter apparatus, the filter apparatus may rotate, for example, at from between about 0.01 rpm to about 30 rpm. In some aspects, the filter apparatus is rotated at from between 0.05 to about 3 rpm. A rotating drum is advantageous because it increases the flow rate of the juice through the apparatus. Such filter apparatuses may be found commercially, for example, from Eimco, Komline Sanderson, or Mansa.

The filter apparatuses disclosed herein may also contain additional components, for example a valve, a doctoring blade, a temperature sensor, a Brix sensor, a turbidity sensor, a pH sensor, a memory component, and/or a processor. This list is not meant to be exhaustive and other components may be included or used in conjunction with the filter apparatus.

According to some aspects, a filter aid is provided that may be, for example, from between about 0.01% to about 5% of the feed juice by weight. The filter aid may be, for example, diatomaceous earth, a simulated diatomaceous earth product, sand, crushed glass, or other similar products now or later known to the art. Suitable filter aids include particles sized from about between 5 microns to about 1000 microns. Suitable filter aids will differ and depend in part on the purpose for which they are being used. Filter aids for orange juice may have different sized particles than filter aids used for apricots. One with skill in the art having the benefit of this disclosure will be able to determine the filter aid appropriate for a particular purpose. According to some aspects, the filter aid may be selected from Perlite (Eagle Pict.), Celite (American Clay), Dicalite (Eucatex), and/or mixtures thereof.

The filter aid may, for example, be formed into a cake prior to passing the feed juice through the filter aid. If the filter apparatus has a filter, the filter aid may be formed into a cake on the filter. It is advantageous to form a cake because forming a good bed of filter aid may lead to a faster flow rate of the juice through the filter aid. Alternately, the filter aid may be mixed with the feed juice to form a slurry. The slurry is then passed over the filter to form a filtrate and a retentate. The amount of the filter aid used is dependent, in part, on the amount of pulp and solids contained in the feed juice. In addition, the amount and size of the solids desired in the filtrate will also in part determine the amount of filter aid used. For example, for every 100 lbs. of feed juice with 10% solids, approximately 1 lb of filter aid will be used. Suitable bed depths may be from between 0.5 inches to about 6 inches. In other aspects, the bed depth may be from 3 to about 5 inches. A person will skill in the art, having the benefit of this disclosure, will be able to determine the proper amount of filter aid to use and the proper bed depth for a particular purpose.

As used here, “passing the feed juice through” includes, for example, substantially all of the feed juice passing through substantially all of the filter aid, substantially all of the feed juice passing through most of the filter aid, etc. The feed juice may be passed through the filter aid in a batch, in a continuous stream, or in any other manner a person with skill in the art having the benefit of this disclosure would find appropriate for their particular purpose. When passing the juice as a batch, for example, a fixed amount of juice is passed through a fixed amount of filter aid. When passing the feed juice in a continuous manner, for example, the filter aid is formed into a cake on the surface of the filter and a continuous stream of feed juice is passed through the filter aid and feed juice. Passing a feed juice in a continuous stream also includes passing the feed juice through a bed of filter aid until it is determined that the filter aid is spent. Suitable determinants of a spent filter aid may include, for example, a cessation of flow through the filter aid and filter, a lower than desirable turbidity of filtrate, decreased flow rate, and other methods known in the art.

According to some aspects the flow rate of the feed juice through the filter aid and filter is from between 5 gpm/square foot to about 20 gpm/square foot. In other aspects, the flow rate may be from 1 to about 7 gmp/square meter. The flow rate may, in part, be determined by the level of solids in the feed juice, the temperature, the vacuum pressure, the viscosity of the feed juice, size of filter aid particles, the filter aid bed depth, etc. It will be apparent to one of skill in the art, having the benefit of this disclosure, how to determine the proper flow rate for their particular purpose.

According to an aspect, the feed juice is passed through the filter aid and the filter to form a retentate and a filtrate. A retentate includes, for example, the material not passed through the filter aid and the filter. The filtrate includes, for example, the material passed through the filter.

The filtrate is one example of a low pulp beverage formed according to this invention. According to some aspects, the filtrate may have, for example, from between about 0.01% to about 2% solids by volume, wherein a substantial amount of the particles are sized from between 30 to about 200 microns. The particles of the feed juice sized from between 200 to about 1000 microns and those below about 30 microns may be substantially removed by the filter aid. The particles remaining in the filtrate may be of different size distributions and will depend in part on the filter aid chosen. The filtrate may also, in some aspects, have from between 3.5° Brix to about 28.5° Brix. The Brix level may be higher or lower and will depend in part on the Brix level of the feed juice.

The filtrate, for example, usually retains a Brix level similar to the feed juice. The Brix level of the filtrate may usually be not more than 2° Brix lower than that of the feed juice. The level of Brix in the filtrate, however, may be determined, in part, by the filter aid and the filter chosen. A person with skill in the art, having the benefit of this disclosure, would be able to determine the level of Brix desirable in the filtrate.

In some aspects, the temperature of the feed juice and retentate is maintained at from between 5° C. to about 30° C. This may be done, for example, by passing the feed juice through a heat exchanger prior to filtering, cooling the conduits the feed juice passes through, cooling the reservoirs of the filter apparatus, etc. The filtrate may also be maintained a temperature below about 30° C. This may be done, for example by passing the filtrate through a heat exchanger, cooling the second reservoir of the filter apparatus, or by filtering the feed juice into a cooled container. Any other method of maintaining the feed juice, the retentate, or the filtrate at about below 30° C. may be employed and will be evident to one with skill in the art having the benefit of this disclosure.

The filtrate, in some aspects, may be further processed. Further processing may be, for example, concentrating, freezing, pasteurizing, mixing with other liquids, centrifuge, debittering, or enzymatic treatment. Other methods of further processing the filtrate will be evident to one with skill in the art having the benefit of this disclosure.

According to some aspects, the filtrate has a cloud that is stable for at least 15 days and may be stable for much longer. In some aspects the cloud is stable for more than 30 days at ambient temperature. The cloud of the filtrate is made of the suspended solid particles of the feed juice that are not filtered out of the feed juice by the filter aid and the filter. It is advantageous to have a stable cloud because consumers prefer a low pulp beverage having a cloud. In some aspects, the cloud is stable for much longer than 30 days. The stability of the cloud may be affected by storage conditions and in some aspects, the low pulp beverage is stored at temperatures below, for example, 4° C. Alternately, the beverage may be stored at ambient temperatures and even at ambient temperatures the cloud may be stable for 15 days or 30 days, or even longer.

Pulp, as used here, includes the fine suspended insoluble solids present in the natural fruit juice and measured as a volume of the sediment collected at the bottom of the vial, which was spun for 10 minutes in a centrifuge relative to the volume of the fruit juice analyzed. Therefore, pulp content is analyzed as a percentage of suspended insoluble solids on a volume basis. Juice, as used here may include any extractable solids from a fruit. The juice extraction process may be carried out by automatic juicing machines commercially available from such manufacturers as FMC, AMC and Centenari. Juice extraction may also be done by hand, by a semi-automated method of juice extraction or by any method known in the art for extracting juice from fruit.

The filtrate or the feed juice may be optionally pasteurized. The pasteurization step helps maintain the storage stability of the feed juice or the filtrate. Pasteurization controls the concentration of the bacteria and other microbes so that the product does not deteriorate on storage, or does not deteriorate when reconstituted after a reasonable period. Moreover, pasteurization reduces the activity of the pectin esterase enzyme. Pectin esterase is believed to be responsible for demethylating the pectin and thus destroying the cloud of the orange juice. Pectin esterase is somewhat active even at 0° C. Thus, the highly preferred compositions herein will contain a minimal level of pectin esterase enzyme.

Pasteurization, for example, may be done by using a high temperature, short residence pasteurization technique. The feed juice or the filtrate is heated to a temperature of from between about 80° C. to about 95° C. for from about 3 to about 25 seconds. The juice concentrate is then rapidly cooled to a temperature of about −10° C. to about 5° C. The system used to pasteurize the juice must be closed and be conducted in a manner such that the juice is not exposed to an oxidative atmosphere. It should be understood that the pasteurization step can be performed at any stage in the processing. Other methods of pasteurization may be used and the methods will be apparent to those with skill in the art having the benefit of this disclosure.

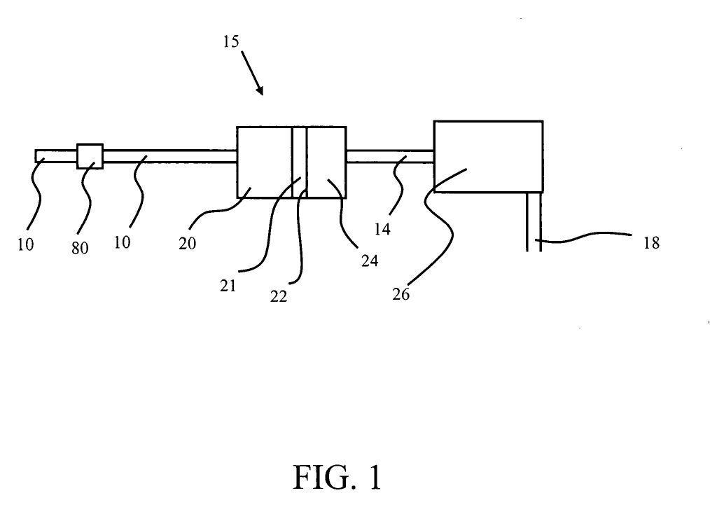

Referring now to FIG. 1, an example of the process to produce a low pulp beverage is disclosed. A feed juice is passed into conduit 10 and is pumped by pump 80 into vacuum filter apparatus 15. The feed juice enters the vacuum filter apparatus 15 into first reservoir 20. The feed juice then passes through filter aid 21 and filter 22 into second reservoir 24 of the vacuum filter apparatus 15. The filtrate exits the filter apparatus through conduit 14 and enters the pasteurization apparatus 26. The filtrate exits the pasteurization apparatus via conduit 18.

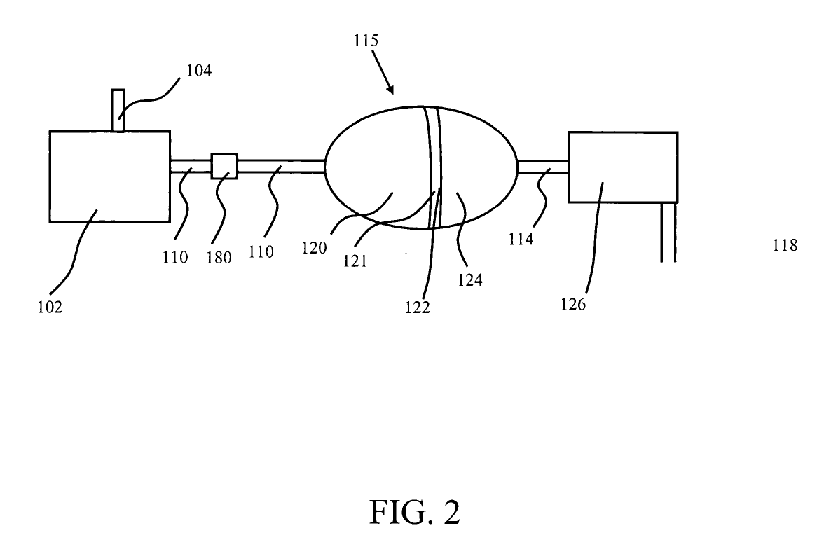

Referring to FIG. 2 a feed juice is passed into conduit 104 and through heat exchanger 102 to be cooled. The feed juice is then pumped by pump 180 through conduit 110 into a rotating vacuum filter apparatus 115. The feed juice enters the rotating vacuum filter apparatus 115 into first reservoir 120. The feed juice then passes through filter aid 121 and filter 122, comprising from about 20 to about 60 microns, into second reservoir 124 of the rotating vacuum filter apparatus 115. The filtrate exits the rotating vacuum filter apparatus through conduit 114 and enters the pasteurization apparatus 126. The filtrate exits the pasteurization apparatus via conduit 118.

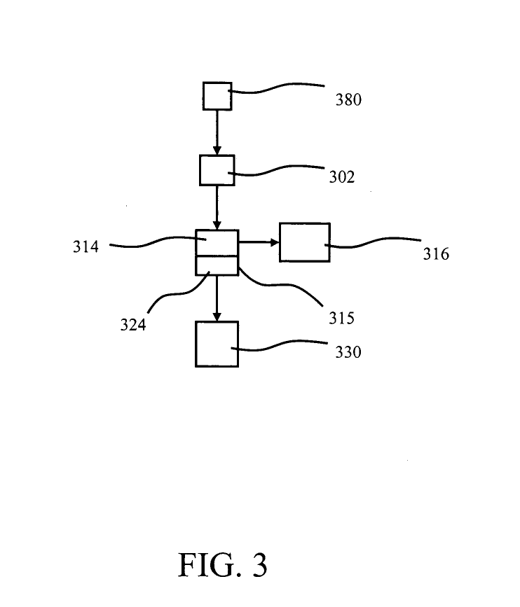

FIG. 3 is a simplified process flow diagram of the process of producing a low pulp beverage with a vacuum filter apparatus. A feed juice is pumped by pump 380 through heat exchanger 302 into the first reservoir 314 of vacuum filter apparatus 315. The feed juice enters the vacuum filter apparatus 315 passes through filter aid and filter into second reservoir 324 of the vacuum filter apparatus 315. The filtrate exits the filter apparatus 315 and flows into storage container 330. The retentate is pumped from the first reservoir 314 into first container 316.

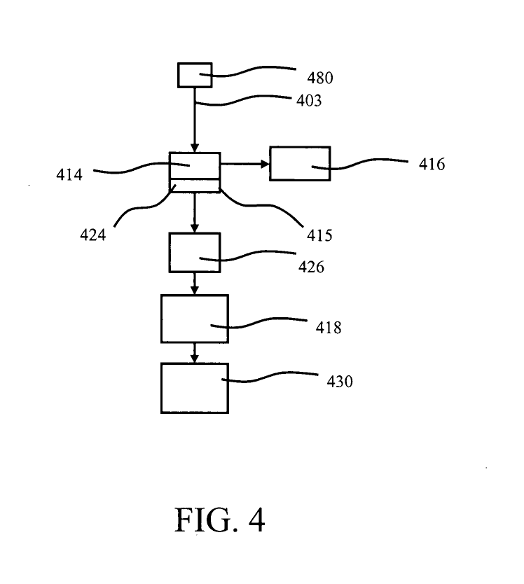

FIG. 4 is a simplified process flow diagram of the process of producing a low pulp beverage with a vacuum filter apparatus. A feed juice is pumped by pump 480 via cooled conduits 403 into the first reservoir 414 of the cooled vacuum filter apparatus 415. The feed juice enters the cooled vacuum filter apparatus 415 passes through filter aid and filter into second reservoir 424 of the cooled vacuum filter apparatus 415. The filtrate exits the filter apparatus 415 and enters the pasteurization apparatus 426. The filtrate exits the pasteurization apparatus 426 and flow into cooled storage container 430. The retentate is pumped from the first reservoir 414 into first container 416.

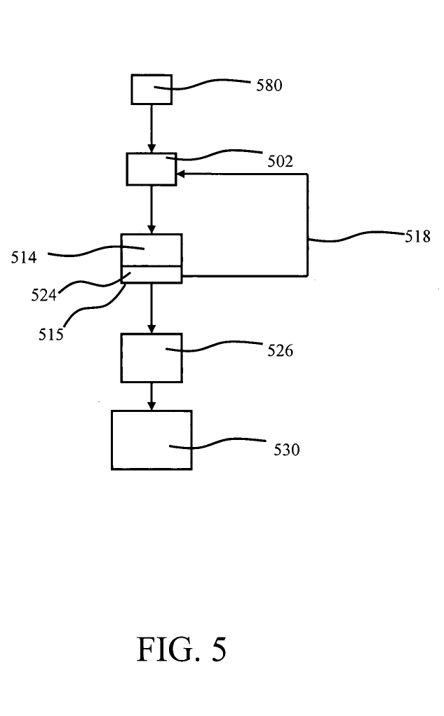

FIG. 5 is a simplified process flow diagram of the process of producing a low pulp beverage with a vacuum filter apparatus wherein the filtrate is passed twice over the filter aid and filter. A feed juice is pumped by pump 580 through heat exchanger 502 into vacuum filter apparatus 515. The feed juice enters the vacuum filter apparatus 515 passes through filter aid and filter into second reservoir 524 of the vacuum filter apparatus 515. The filtrate exits 518 the filter apparatus 515 and is passed a second time through the filter aid and filter. The second filtrate then enters the pasteurization apparatus 526. The filtrate exits the pasteurization apparatus 526 and flows into storage container 530.

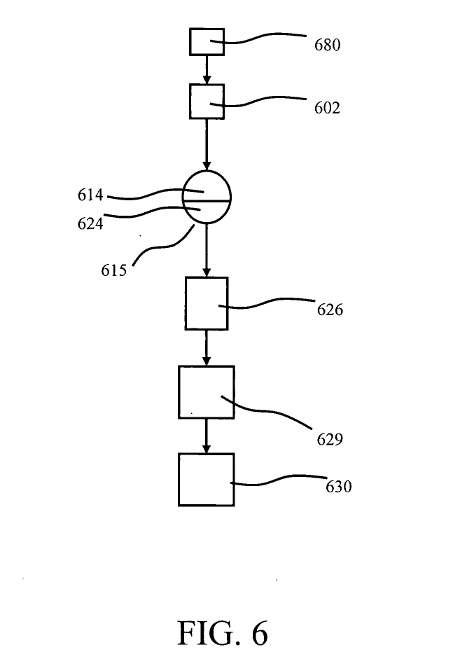

FIG. 6 is a simplified process flow diagram of the process of producing a low pulp beverage with a rotating vacuum filter apparatus. A feed juice is pumped by pump 680 through heat exchanger 602 into rotating vacuum filter apparatus 615. The feed juice enters the rotating vacuum filter apparatus 615 into first reservoir 614 passes through filter aid and filter into second reservoir 624 of the rotating vacuum filter apparatus 615. The filtrate exits the rotating vacuum filter apparatus 615 and enters the pasteurization apparatus 626. The filtrate exits the pasteurization apparatus 626 and flows into concentration apparatus 629 and then into storage container 630.

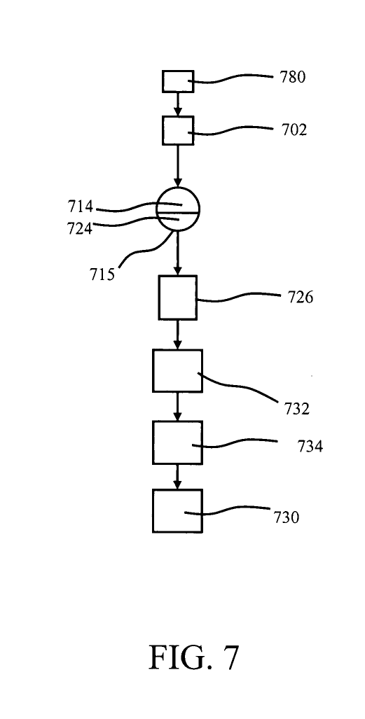

FIG. 7 is a simplified process flow diagram of the process of producing a low pulp beverage with a rotating vacuum filter apparatus wherein the low pulp beverage is further processed. A feed juice is pumped by pump 780 through heat exchanger 702 into rotating vacuum filter apparatus 715. The feed juice enters the rotating vacuum filter apparatus 715 into first reservoir 714 passes through filter aid and filter into second reservoir 724 of the rotating vacuum filter apparatus 715. The filtrate exits the rotating vacuum filter apparatus 715 and enters the pasteurization apparatus 726. The filtrate exits the pasteurization apparatus 726 and flows into a container 732 wherein the filtrate is chilled to less than 15° C. After the filtrate is chilled to less than 15° C. the filtrate flows into a filter concentration apparatus 734 wherein the filtrate is concentrated. After the juice is concentrated, the juice flows into storage container 730. It should be understood that filtrate, as used here, may include or be used interchangeably with the term a low pulp beverage.

### EXAMPLE 1

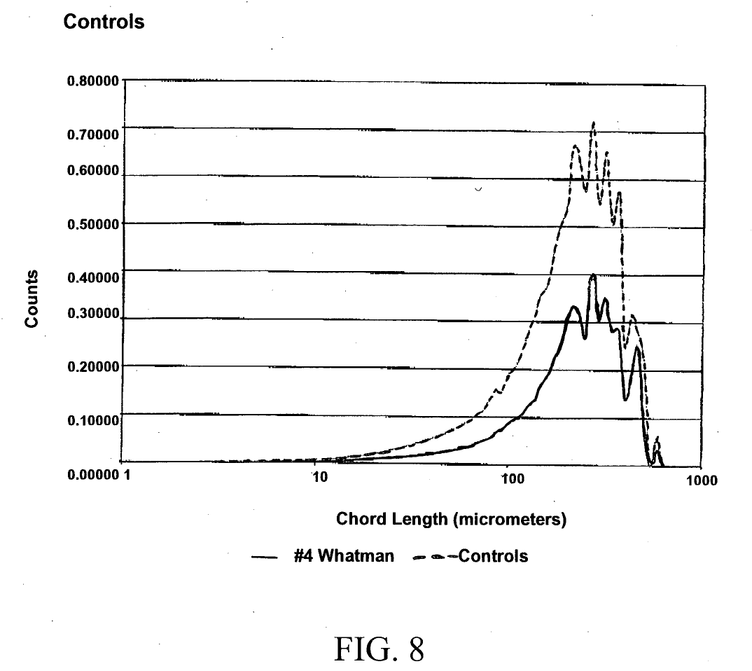

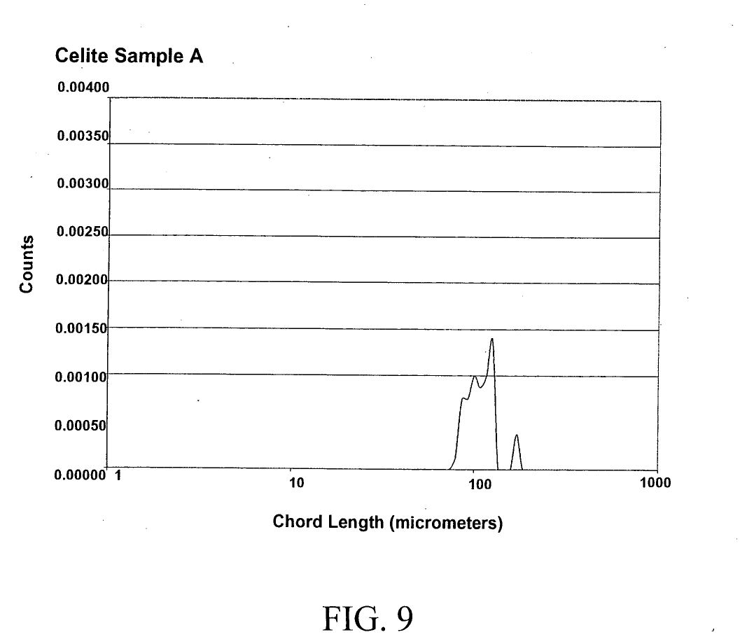

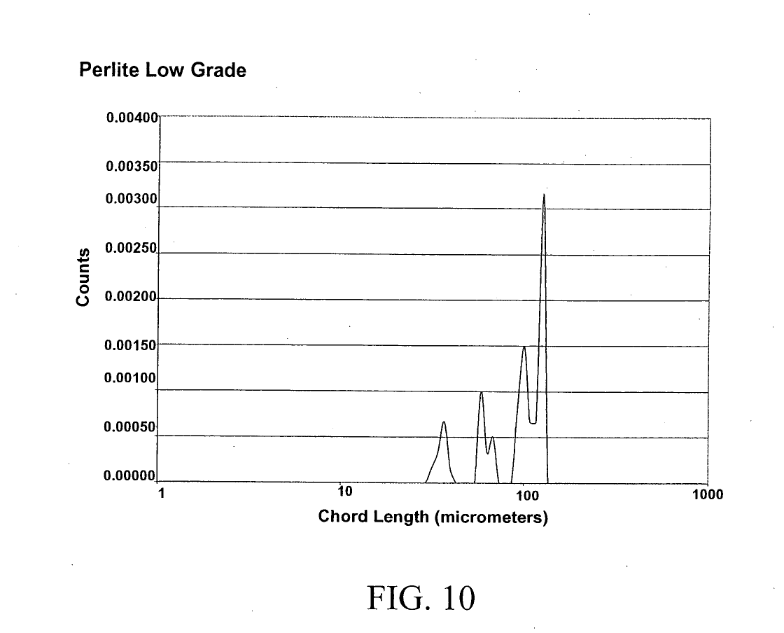

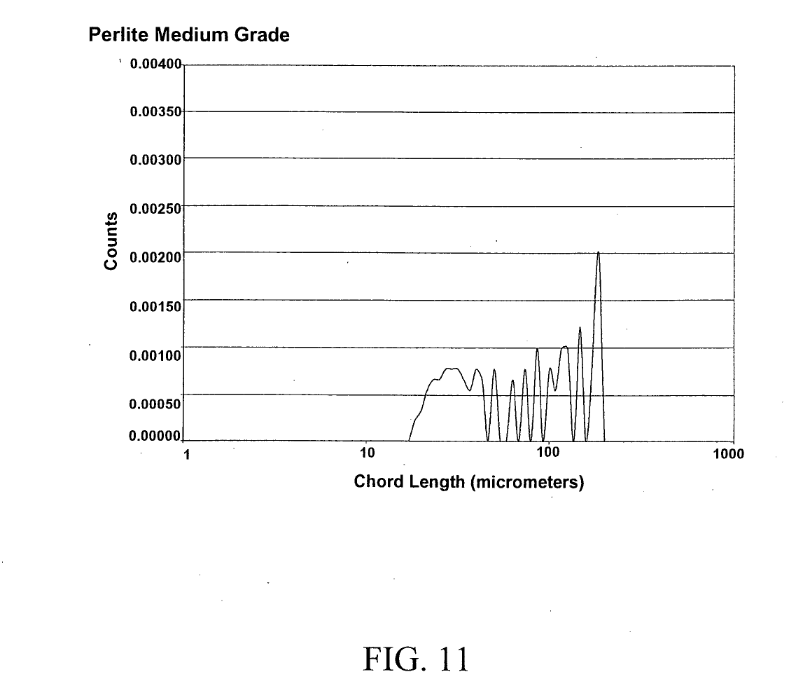

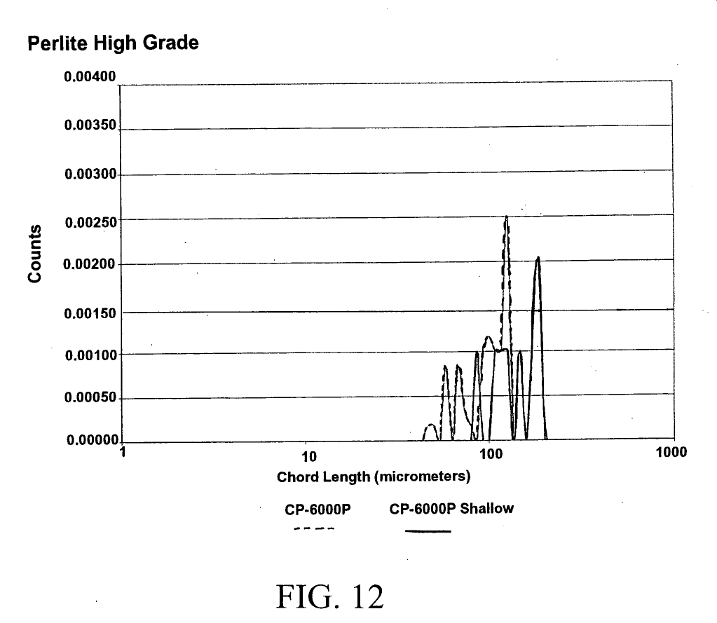

Frozen concentrated orange juice was obtained from Bebedouro, Brazil. The frozen concentrated juice was reconstituted to 11.2° Brix for filtration. The filter aid was mixed well with deionized water and slowly poured onto a Buchner funnel outfitted with #4 Whatman filter paper. The bed depth was approximately 1.0-1.5 mm. Two hundred milliliters of orange juice was filtered with each variation of filter media, as shown in Table A below. One control sample was not filtered and another was filtered only through the #4 Whatman paper. The turbidity was measured on a Hach 2100AN Tubidimeter. The same samples were also subjected to particle size analysis. The particle size (chord length) was measured with a Lasentec Model D600-HC-K particle counter. This data demonstrates that according to certain aspects of the invention, particles from between 200 to about 1000 microns and particles below 30 microns are substantially removed. Particles from between about 30 to about 200 microns are only reduced. Referring now to FIGS. 8-12, these graphs show the results of the particle size analysis. FIG. 8 is a graph of the particle size distribution of unfiltered juice and the juice filtered with only #4 Whatman paper. The graph demonstrates the size distribution of solids suspended in the feed juice. The graph demonstrates that the particles are sized from between about 5 microns to about 1000 microns. Referring now to FIG. 9, results of the Celite sample A are shown. In addition to reducing the turbidity to a reading of 127 NTU, the Celite also substantially reduced the particles below about 75 microns and above 250 microns. FIG. 10 shows the results obtained from filtering the feed juice through Perlite low grade. Similar results as the Celite Sample A were obtained. FIG. 11 shows the results obtained from Perlite medium grade. The filtrate retained a desirable turbidity of 1044 NTU and a substantial portion of the particles sized from about 30 to about 250 microns. The particles sized below 30 and above 250 microns were substantially removed. FIG. 12 is a graph of the results of the Perlite high grade and Perlite high grade with a shallow bed. The Perlite high grade filtrate had a turbidity of 112 NTU and removed a substantial amount of particles sized below 80 microns and those sized above 400 microns. The Perlite high grade with a shallow bed showed a desirable turbidity of 1033 NTU. The shallow bed also substantially removed particles sized above 200 microns and those below 50 microns, while the filtrate retained most of the particles sized from between 50 to about 200 microns.

TABLE A

| Sample | Turbidity (NTU) |
|---|---|
| Control | 2747 |
| Whatman #4 paper | 2611 |
| Celite sample A | 127 |
| Perlite low grade | 14.2 |
| Perlite medium grade | 1044 |
| Perlite high grade | 112 |
| Perlite high grade (shallow bed) | 1033 |

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

Although the invention has been defined using the appended claims, these claims are illustrative in that aspects of the invention and are intended to include the elements and steps described herein in any combination or sub combination. Accordingly, there are any number of alternative combinations for defining the invention, which incorporate one or more elements from the specification, including the description, claims, and drawings, in various combinations or sub combinations. It will be apparent to those skilled in the relevant technology, in light of the present specification, that alternate combinations of aspects of the invention, either alone or in combination with one or more elements or steps defined herein, may be utilized as modifications or alterations of the invention or as part of the invention. It may be intended that the written description of the invention contained herein covers all such modifications and alterations.

What it claimed is:

1. A process of producing a low pulp beverage, comprising:
providing a feed juice;
providing a filter apparatus;
providing a filter aid; and
passing the feed juice through the filter aid in the filter apparatus to form a retentate and a filtrate, wherein the filtrate has from between 0.01% to about 2% solids by volume.

2. The process of claim 1, further comprising maintaining the temperature of the feed juice at from between 5° C. to about 30° C.

3. The process of claim 1, further comprising passing the feed juice through a heat exchanger.

4. The process of claim 1, wherein the filter aid comprises from 0.01% to about 5% of the feed juice by weight.

5. The process of claim 1, wherein the filter aid comprises diatomaceous earth.

6. The process of claim 1, wherein the filter aid is selected from the group consisting of: Perlite, Celite, Dicalite, and mixtures thereof.

7. The process of claim 1, wherein the passing the feed juice through the filter aid is done in a batch.

8. The process of claim 1, wherein the passing the feed juice through the filter aid is done in a continuous manner.

9. The process of claim 1, wherein the filter apparatus is a vacuum filter apparatus.

10. The process of claim 1, further comprising providing vacuum pressure on the filter apparatus at from between 5 mm Hg to about 20 mm Hg.

11. The process of claim 1, further comprising providing vacuum pressure on the filter apparatus at from between 10 inches Hg to about 20 inches Hg.

12. The process of claim 1, wherein the filter apparatus is a rotating filter apparatus.

13. The process of claim 1, further comprising rotating the filter apparatus at from between about 0.01 rpm to about 30 rpm.

14. The process of claim 1, further comprising rotating the filter apparatus at from between about 0.05 rpm to about 3 rpm.

15. The process of claim 1, wherein the passing the feed juice through the filter aid occurs at a rate of from between 5 gpm/square foot to about 20 gpm/square foot.

16. The process of claim 1, wherein the passing the feed juice through the filter aid occurs at a rate of from between 1 gpm/square meter to about 7 gpm/square meter.

17. The process of claim 1, wherein the filter apparatus comprises a filter comprising pores of from between 30 to about 50 microns.

18. The process of claim 17, wherein the filter is selected from the group consisting of: cloth, sintered glass, paper, plastic mesh, polymer mesh, and ceramic mesh.

19. The process of claim 17, further comprising mixing the feed juice with the filter aid to form a slurry and passing the slurry through the filter.

20. The process of claim 1, further comprising forming the filter aid into a cake prior to passing the feed juice through the filter aid.

21. The process of claim 1, wherein the feed juice comprises from between 5° Brix to about 65° Brix.

22. The process of claim 1 wherein the feed juice is derived from citrus fruit.

23. The process of claim 1, wherein the feed juice is derived from oranges.

24. The process of claim 1, wherein the feed juice is derived from the group consisting of: apricot, cranberry, blueberry, grape, orange, lemon, lime, peach, grapefruit, tangerine, pear, papaya, banana, pineapple, apple, kiwi, raspberry, strawberry, aloe, guava, mango, or a mixture.

25. The process of claim 1, wherein the feed juice is derived from a processed juice.

26. The process of claim 1, wherein particles of the feed juice sized from between 200 to about 1000 microns and from 1 to about 30 microns are substantially removed by the filter aid.

27. The process of claim 1, wherein the particles sized from between 30 to about 200 microns of the feed juice are not substantially reduced by the filter aid.

28. The process of claim 1, wherein the filtrate has a cloud stable for at least 15 days.

29. The process of claim 1, wherein the filtrate has from between 3.5° Brix to about 28.5° Brix.

30. The process of claim 1, wherein the filter aid has a bed depth of from between 0.5 to about 6 inches.

31. The process of claim 1, wherein the filter aid has a bed depth of from between 3 to about 5 inches.

32. The process of claim 1, wherein the filter has an area of from between 1 to about 80 meters squared.

33. The process of claim 1, wherein the filter has an area of from between 40 to about 60 meters squared.

34. A process of producing a low pulp beverage, comprising:
providing a feed juice;
providing a filter apparatus having a filter comprising an area of from between 40 to about 60 meters squared;
providing vacuum pressure on the filter apparatus at from between 10 inches Hg to about 20 inches Hg;
providing a filter aid comprising from between 0.01% to about 5% of the feed juice by weight, wherein the filter aid has a bed depth of from between 3 to about 5 inches; and
passing the feed juice through the filter aid in the filter apparatus to form a retentate and a filtrate, wherein the filtrate has from between 0.01% to about 2% solids by volume.

35. A low pulp beverage, comprising: 0.01% to about 2% solids by volume, wherein a substantial portion of solids are particles sized from between 30 to about 200 microns; and
a cloud, wherein the cloud is stable for at least 15 days.

36. The low pulp beverage of claim 35, further comprising from between 3.5° Brix to about 28.5° Brix.

37. A low pulp beverage produced by the process, comprising:
providing a feed juice;
providing a filter apparatus;
providing a filter aid; and
passing the feed juice through the filter aid to form a retentate and a filtrate, wherein the filtrate has from between 0.01% to about 2% solids by volume.

38. A low pulp beverage produced by the process according to claim 37, further comprising passing the feed juice through a heat exchanger.

39. A low pulp beverage produced by the process according to claim 37, further comprising providing vacuum pressure on the filter apparatus at from between about 5 mm Hg to about 20 mm Hg.

40. A low pulp beverage produced by the process according to claim 37, further comprising rotating the filter apparatus at from between 5 rpm to about 30 rpm.

41. A low pulp beverage produced by the process, comprising:
providing a feed juice comprising from between 5° Brix to about 30° Brix;
passing the feed juice through a heat exchanger;
providing a filter apparatus comprising a filter comprising pores from about 20 to about 60 microns;
providing a filter aid comprising from between about 0.1% to about 2% by weight of the feed juice;
providing vacuum pressure on the filter apparatus at from between about 5 mm Hg to about 20 mm Hg;
rotating the filter apparatus at from between 5 to about 30 rpm; and
filtering the juice through the filter aid and the filter at a rate of from between 5 to about 20 gpm/square foot to produce a filtrate and a retentate, wherein the filtrate has from between about 0.01% to about 2% solids by volume and a cloud stable for at least 15 days.

42. A low pulp beverage produced by the process, comprising:
providing a feed juice comprising from between 5° Brix to about 30° Brix;
passing the feed juice through a heat exchanger;
providing a filter apparatus comprising a filter comprising pores from about 20 to about 60 microns and having an area of from between 1 to 80 m²;
providing a filter aid comprising from between about 0.1% to about 2% by weight of the feed juice having a bed depth of from between 1 to 6 inches;
providing vacuum pressure on the filter apparatus at from between about 10 inches Hg to about 20 inches Hg;
rotating the filter apparatus at from between 0.05 to about 3 rpm; and
filtering the juice through the filter aid and the filter at a rate of from between 1 to about 7 gpm/square meter to produce a filtrate and a retentate, wherein the filtrate has from between about 0.01% to about 2% solids by volume and a cloud stable for at least 15 days.
